(19) United States
(12) Patent Application Publication
(10) Pub. No.: US 2025/0045580 A1
(43) Pub. Date: Feb. 6, 2025

(54) DEVICE, SYSTEM AND METHOD FOR PREDICTING AN INTENTION OF A USER

(71) Applicant: SHOPEE IP SINGAPORE PRIVATE LIMITED, Singapore (SG)

(72) Inventors: Peng WANG, Singapore (SG); Chenglong CHEN, Shenzhen (CN)

(21) Appl. No.: 18/790,249

(22) Filed: Jul. 31, 2024

(30) Foreign Application Priority Data
Aug. 1, 2023 (SG) 10202302198Q

(51) Int. Cl. G06N 3/08

(52) U.S. Cl. CPC G06N 3/08

(57) ABSTRACT

Aspects of the disclosed technology provide solutions for predicting an intention of a user of a chatbot system. The method can include steps for: receiving or obtaining feature data from a plurality of feature sources; classifying the feature data into a plurality of feature groups; extracting the feature data using a first machine learning layer; and modelling at least one relationship between one group of feature data and another group of feature data in the plurality of feature groups using a second machine learning layer. Systems and machine-readable media are also provided.

### CROSS REFERENCE TO RELATED APPLICATIONS

This patent application claims the benefit and priority of Singaporean patent application number 10202302198Q, filed with the Intellectual property Office of Singapore on Aug. 1, 2023 entitled “DEVICE, SYSTEM AND METHOD FOR PREDICTING AN INTENTION OF A USER,” the content of which is incorporated by reference in its entirety.

### TECHNICAL FIELD

Various aspects of this disclosure relate to devices, systems, and methods for predicting intentions of users. The disclosure is particularly suitable for, but not limited to conversational interfaces, such as chatbot systems, and using such chatbot system to predict intention of users.

### BACKGROUND

The following discussion of the background art is intended to facilitate an understanding of the present disclosure only. It should be appreciated that the discussion is not an acknowledgement or admission that any of the material referred to was published, known or is part of the common general knowledge of the person skilled in the art in any jurisdiction as of the priority date of the disclosure.

Automated conversation systems, such as chatbot systems, exist to facilitate human users in navigation a website, such as an e-commerce platform. A typical automated conversation system may follow decision trees in generating a machine-human chatbot conversation. Such systems typically follow a decision driven menu in selecting response to user inputs. These systems may analyse user input(s) to determine a user's intent and to respond using prepared decision tree responses.

However, current chatbot systems are not able to take into account complexities in system behaviour arising from multiple input sources, multiple optimization goals or targets, and varying or inconsistent human user behaviour.

Accordingly, there exists a need to provide a more robust and/or efficient chatbot system to address the aforementioned drawbacks, at least in part.

### SUMMARY

Various aspects of the disclosure concern a method, system for predicting an intention of a user of a chatbot system.

According to an aspect of the disclosure, there is provided a method for predicting an intention of a user of a chatbot system, the method comprising the steps of: receiving or obtaining feature data from a plurality of feature sources; classifying the feature data into a plurality of feature groups; extracting the feature data using a first machine learning layer; and modelling at least one relationship between one group of feature data and another group of feature data in the plurality of feature groups using a second machine learning layer.

In some embodiments, the first machine learning layer comprises a first multi-layer perceptron neural network, and the second machine learning layer comprises a second multi-layer perception neural network.

In some embodiments, the method further comprises a step of calculating a probability of the intention based on the modelled at least one relationship.

In some embodiments, the method further comprises displaying the intention, in the form of one or more suggestions to the user for selection as input to the chatbot system.

In some embodiments, the method further comprises a step of detecting whether the user has entered the chatbot system based on a pre-determined user login data.

In some embodiments, in a positive determination that the user has entered the chatbot system, the method further comprise obtaining feature data associated with the user based on the pre-determined user login data.

In some embodiments, the feature data associated with the user may include an intent feature data group, and a user specific feature data group.

In some embodiments, the user specific feature data includes past transaction data of the user, user profile data, credit status data of the user.

In some embodiments, the intent feature data includes a question text data, a one-hot intent data, and a one-hot category data.

In some embodiments, the feature data includes at least one of a real time feature and an offline feature.

In some embodiments, the first machine learning layer is implemented as a multi-gate mixture-of-experts model.

According to another aspect of the disclosure there is provided a system for predicting an intention of a user of a chatbot system, the system comprising at least one processor configured to model at least one relationship between one group of feature data and another group of feature data in the feature groups using a machine learning layer; identify at least one intention of the user based on the at least one relationship between one group of feature data and another group of feature data in the feature groups; and display, in a graphical user interface, the at least one intention in the form of one or more suggestions to the user for selection as input to the chatbot system.

In some embodiments, the machine learning layer comprises a multi-layer perception neural network.

In some embodiments, the processor comprises a graphical user interface, the graphical user interface configured to display the intention, in the form of one or more suggestions to the user for selection as input to the chatbot system.

In some embodiments, the processor is configured to detect whether the user has entered the chatbot system based on a pre-determined user login data.

In some embodiments, in a positive determination that the user has entered the chatbot system, the processor is configured to obtain feature data associated with the user based on the pre-determined user login data.

In some embodiments, the feature data associated with the user includes an intent feature data group, and a user specific feature data group.

In some embodiments, the user specific feature data includes past transaction data of the user, user profile data, credit status data of the user.

In some embodiments, the intent feature data includes a question text data, a one-hot intent data, and a one-hot category data.

According to another aspect of the disclosure there is provided a computer program element comprising program instructions, which, when executed by one or more processors, cause the one or more processors to perform the method as described.

According to another aspect of the disclosure there is provided a computer-readable medium comprising program instructions, which, when executed by one or more processors, cause the one or more processors to perform the method as described.

According to another aspect of the disclosure there is provided a user interaction system, the user interaction system comprising a chatbot system, the chatbot system comprises the system of as described, the system configured as an intent prediction module to detect a user entering the chatbot system and provide the intention in the form of one or more suggestions to the user; a typing suggestion module, the typing suggestion module configured to detect a selected suggestion and provide further suggestion(s) as the user enters or keys in the selected suggestion; an intent recognition module, the intent recognition module configured to detect the selected suggestion of the user, the intent recognition module further configured to generate a response based on the selected suggestion; and a related article suggestion module, the related article suggestion module configured to display a list of related articles, the list of related articles related to the selected suggestion and the response.

In some embodiments, the related article suggestion module comprises a relevance model, the relevance model trained to produce a ranked output set according to the degree of relevance between the list of related articles and the selected suggestion or the response.

In some embodiments, the related article suggestion module includes a reranking module, the reranking module configured to re-rank the ranked output set based on at least one user feedback.

In some embodiments, the at least one user feedback comprises a positive or negative determination that the user subsequently selects any one of the related articles from the ranked output set.

In some embodiments, the reranking module may be configured to obtain user behaviour data for the reranking.

It should be noted that embodiments described in context of the method for predicting an intention of a user are analogously valid for the prediction engine, device, and/or system, and vice versa.

### BRIEF DESCRIPTION OF THE DRAWINGS

The invention will be better understood with reference to the detailed description when considered in conjunction with the non-limiting examples and the accompanying drawings, in which:

FIG. 1 is a schematic flow chart depicting a method for predicting an intention of a user;

FIG. 2A is a schematic diagram of a system for predicting an intention of a user;

FIG. 2B is a schematic diagram of an intent prediction service, the intent prediction service arranged in communication with a chatbot system;

FIG. 2C is a schematic diagram of an example of a feature service, the feature service configured to receive and/or send feature data from one or more sources of the chatbot system;

FIG. 3 is an example of a graphical user interface of a user of a chatbot system of an e-commerce platform;

FIG. 4A is a schematic diagram of an embodiment of the intention prediction service comprising two machine learning layers;

FIG. 4B is a schematic diagram showing another embodiment of the intention prediction service, modelled as a multi-task model;

FIG. 4C is a schematic diagram showing an embodiment of an auto-training pipeline of an auto-training function of the intent prediction training module;

FIG. 4D is a schematic diagram showing another embodiment of the prediction service, wherein the feature data may be grouped according to an intent feature data group, or a user specific feature data group; and

FIG. 5 is a schematic diagram of the data connection between the intention prediction service and one or more other modules of a chatbot system.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized, and structural and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

As used herein, the term “chatbot” refers broadly to a computer program or computer-executable instructions to simulate an intelligent conversational interface that enables interactive chat sessions with human users via auditory or textual methods. A chatbot may include one or more virtual agents for intelligent conversations through online platforms for various practical purposes such as customer service and information delivery. Chatbots can include standalone applications or can be integrated with various websites as a platform/tool for providing assistance to users. In some embodiments, the chatbot may provide a conversational experience for interaction with users. For instance, a user can type a question and the chatbot will attempt to interpret it, and then provide an answer. To maximize the relevancy and/or accuracy of the answer, the chatbot may need to be trained on different kinds of inputs received from the users in order to modify the chatbot's responses, which will enhance the customer experience while interacting with the chatbot. In some embodiments, training of a chatbot may include artificial intelligence, such as machine learning algorithms or methods, and such training may further include supervised learning, unsupervised learning, and/or hybrid learning methods.

As used herein, the term “processor(s),” as used herein, includes one or more electrical circuits capable of processing data, e.g., processing circuits. A processor may include analog circuits or components, digital circuits or components, or hybrid circuits or components. Any other kind of implementation of the respective functions which will be described in more detail below may also be understood as a “circuit” in accordance with an alternative embodiment. A digital circuit may be understood as any kind of a logic implementing entity, which may be special purpose circuitry or a processor executing software stored in a memory, or a firmware.

As used herein, the term “data” may be understood to include information in any suitable analog or digital form, for example, provided as a file, a portion of a file, a set of files, a signal or stream, a portion of a signal or stream, a set of signals or streams, and the like. The term data, however, is not limited to the aforementioned examples and may take some forms and represent any information as understood in the art.

As used herein, the term “obtain,” as used herein, refers to the processor which actively obtains the inputs, or passively receives inputs from one or more sensors or data source. The term obtain may also refer to a processor, which receives or obtains inputs from a communication interface, e.g., a user interface. The processor may also receive or obtain the inputs via a memory, a register, and/or an analog-to-digital port.

As used herein, the term “intent predict” includes various forms of prediction, including the use of one or more artificial intelligence-based prediction module, for the optimization of one or more objectives. The one or more objectives may include a click-through rate prediction, a resolution prediction, and a category prediction.

As used herein, the term “module” refers to, or forms part of, or include an Application Specific Integrated Circuit (ASIC); an electrical/electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

In the following, embodiments will be described in detail.

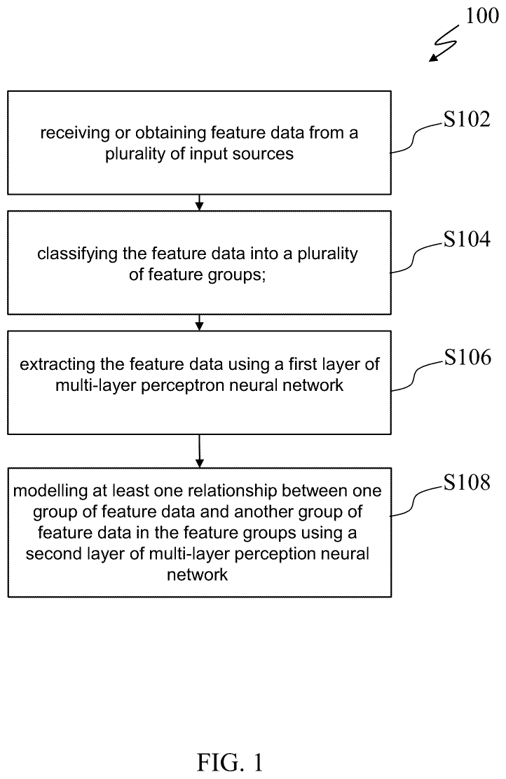

According to an aspect of the disclosure and with reference to FIG. 1, there is provided a method 100 for predicting an intention of a user, or one or more users, of a chatbot system, the method comprising the steps of:
Step S102: receiving or obtaining feature data from a plurality of feature sources;
Step S104: classifying the feature data into a plurality of feature groups;
Step S106: extracting the feature data using a first machine learning layer; and
Step S108: modelling at least one relationship between one group of feature data and another group of feature data in the plurality of feature groups using a second machine learning layer.

The method 100 may be implemented in a chatbot system of an e-commerce platform. In some embodiments, the method 100 may be executed in an intent prediction module of the chatbot system.

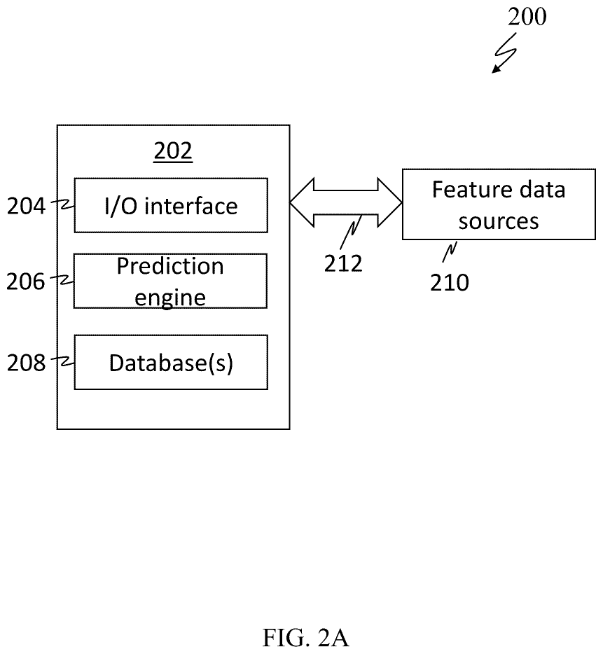

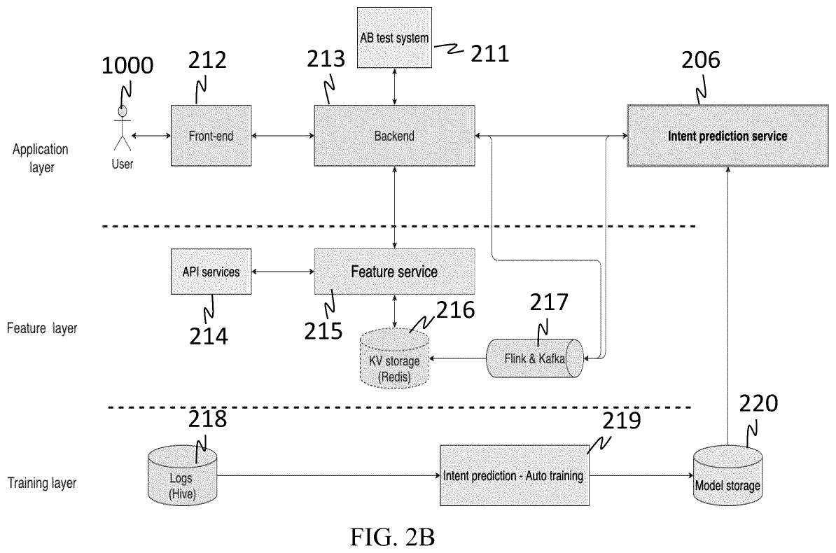

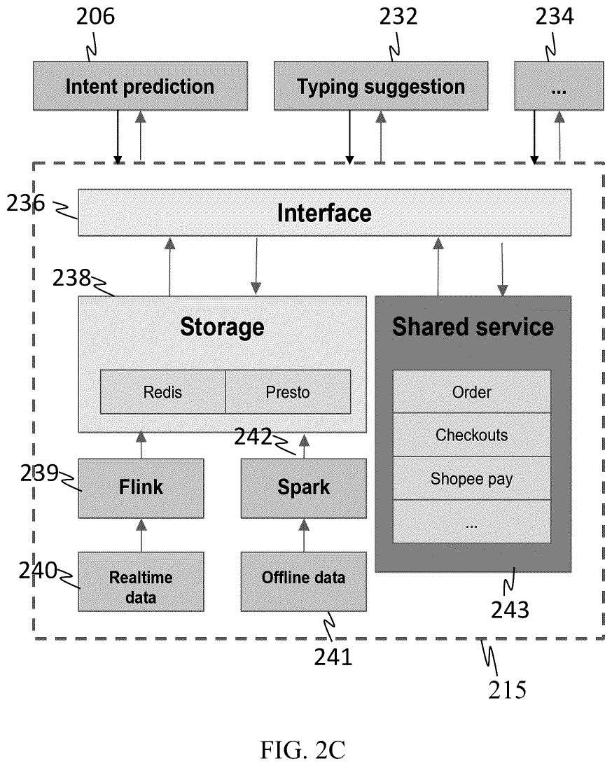

FIG. 2A is a schematic diagram of a system 200 for predicting an intention of a user of a chatbot system, the system comprising at least one processor 202 configured to receive or obtain feature data from a plurality of feature sources; classify the feature data into a plurality of feature groups; extract the feature data using a first machine learning layer; and model at least one relationship between one group of feature data and another group of feature data in the feature groups using a second machine learning layer.

The processor 202 may be a server computer or part thereof. The server computer may be a single server or comprise a plurality of distributed servers. In some embodiments, the server computer may be a remote server, such as a cloud server.

The processor 202 may include an input/output interface 204, a prediction engine 206, and one or more databases 208. The I/O interface 204 may comprises various hardware and/or software to obtain or receive feature data from one or more feature data sources 210. In some embodiments, the I/O interface 204 may include wired or wireless communication interface to obtain or receive feature data 212 from the feature data sources 210.

The prediction engine 206 may be an artificial intelligence-based predictor, particularly a machine learning based predictor. The prediction engine 206 may comprise a first machine learning layer to execute step 106, and a second machine learning layer to execute step 108.

The processor 202 may comprise one or more databases 208 for storage of different types of data. In some embodiments, the one or more databases 208 may be configured to store at least one of the following: feature data 212 used as input for the prediction engine 206, training data used to train the first machine learning layer and/or the second machine learning layer, system-related data, etc.

FIG. 2B shows an embodiment of the prediction engine 206 arranged in communication with a chatbot system. The chatbot system may comprise various components referenced as 211 to 220. The chatbot system may comprise a front end 212 for a user 1000 to interact and access the chatbot system. The front end 212 may be linked to a backend 213. The backend 213 may be configured to send and receive feature data from a feature service 215. The chatbot system may include a test system 211, such as an AB test system, for testing the online performance of different strategies or models associated with different modules of the chatbot system.

The feature service 215 may be configured to send and receive feature data from an API service 214 and a Key-value (KV) storage (Redis) database 216. The KV storage database 216 may in turn be configured to receive streaming data from a data processing framework and/or an embeddable library, such as, but not limited to, a Flink & Kafka framework 217. The backend 213 may also be arranged in data communication with the Flink & Kafka framework 217 to receive and/or send streaming data to or from the same.

The intent prediction service 206 may be configured to be trained periodically, at every pre-determined time interval, or as and when required. In some embodiments, the intent prediction service 206 may be trained continuously. The prediction service 206 may obtain data from a model storage database 220. The model storage database 220 may be configured to store, for various input feature data, corresponding predicted output intent. The model storage database 220 may be configured to receive trained data from an intent prediction training module 219.

The intent prediction training module 219 may be configured to receive input data for automatic training. The input data may be stored in log database 218.

The log database 218 may comprise historical chatbot log entries. In some embodiments, the log database 218 may be a distributed, fault-tolerant data warehouse system. The log database 218 may be configured to facilitate the performance of analytics at a relatively massive scale. In some embodiments, the log database 218 may be configured as an Apache™ HIVE database.

FIG. 2C shows an example of a feature service 215. The feature service 215 may be configured to send feature data to one or more modules of the chatbot system in response to one or more data requests from the one or more modules. The one or more modules may include the intent prediction module 206, a typing suggestion module 232, and other modules 234 which may include an intent recognition module, a related article module, etc. The feature service 215 may be configured to handle data from multiple sources, the data from multiple sources in one or more different data formats. For example, feature data from an interface, such as an application programming interface (API) 236, a real-time data stream 240 (preprocessed using Flink 239), and offline data 241 (preprocessed using Spark 242), may be stored into a KV storage 238.

The feature service 215 also provides an easy-to-use interface 236, the interface 236 connected in data communication with one or more other shared services 243 of the chatbot system service send and/or collect data from other services 243.

In some embodiments, the feature service 215 can handle various I/O complexity based on a unified data structure obtained from the real-time data stream 240, the offline data 241, and the application programming interface (API) 236. In some embodiments, such unified data structure may be implemented using a high-level programming language, such as, but not limited to, the Python programming language.

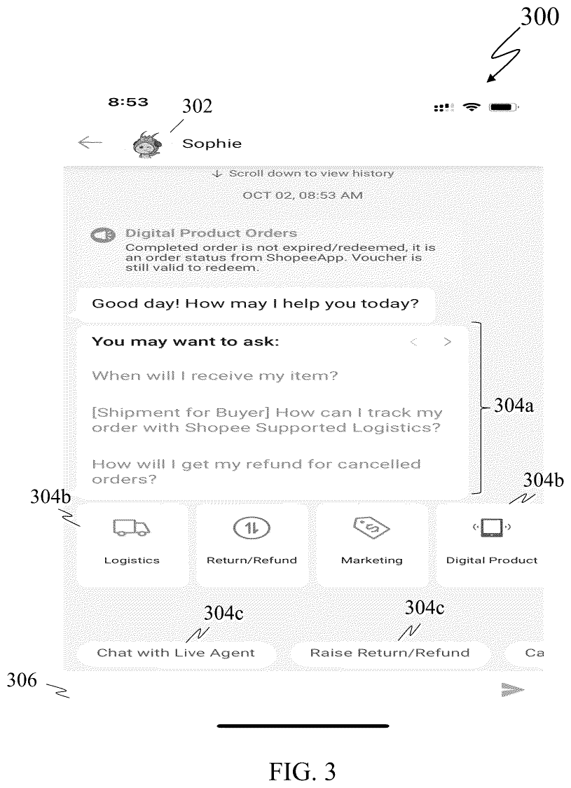

FIG. 3 shows a graphical user interface (GUI) 300 of a user of a chatbot system of an e-commerce platform. Prior to the user entering the chatbot system via the GUI 300, the user may be provided with a login page to provide the necessary user identifier, password, added security information/further authentication information.

The GUI 300 may display the chatbot information 302 and display a customized list of predicted intentions. In some embodiments, the predicted intentions may be one or more suggestions, in the form of one or more questions 304a as shown in the GUI 300. It is appreciable that the predicted intentions may be selected by the user of the chatbot system for input to the input text box 306. Any selected entries from the predicted intentions may be tagged as an “intended entry” and used for future prediction of intentions. In some embodiments, the predicted intentions may include one or more interactive buttons 304b as shown in the GUI 300, or may include other interface elements 304c shown just above the input text box 306.

It is appreciable that the predicted intentions are displayed before the user enters any input into the input text box 306.

An embodiment of the operation of the method 100 and system 200 will next be described with reference to FIG. 2A, FIG. 2B, and FIG. 3. In some embodiments, the chatbot system may form part of an e-commerce platform. and, as a result, the predicted intentions may relate to actions, functions, products, or services provided by the e-commerce platform.

A user 1000 may access the frontend 212 of a chatbot system using his/her login data/credentials, which may include two or more levels of authentication. Such authentication may include biometric authentication, password-based authentication, etc. The backend 213 may be configured to detect whether the user has entered the chatbot system based on the login data. In a positive determination that the user 1000 has entered the chatbot system, the feature data associated with the user based on the login data may be used.

Upon successful login by the user 1000 into the chatbot system, the frontend 212 is configured to display the GUI 300 with the chatbot information/details 302, such as a name of the chatbot, for example, “Sophie”. The backend 213 is configured to retrieve feature data from the feature service 216 relating to the user 1000. Examples of feature data may include historical transactions performed by the user 1000 using the e-commerce platform via the chatbot system and/or other interface, previous records of chatbot usage by the user 1000, intention(s) selected by the user 1000 previously (e.g., clicks), user actions, or transactions on the e-commerce platform, user preferred categories of goods and/or services, user current payment status, for example, whether the user 1000 has an overall credit or debit vis-à-vis the e-commerce platform.

In general, the feature data may be grouped between an intent feature data group, a user specific feature data group, or other grouping. The user specific feature data includes, for example, past transaction data of the user, user profile data, credit status data of the user. The intent feature data may include, for example, a question text data, a one-hot intent data, and a one-hot category data.

It is appreciable that the feature data may include real time feature data and offline feature data.

In some embodiments, the retrieved feature data may be sent to the intent prediction service 206 for prediction of one or more intentions 304. The prediction may include comparing one or more candidate predictions with the data retrieved from the model storage 220. In some embodiments, the intent prediction service may include an artificial neural network, and the predicted intent may label data, the label data including one or more questions that a user may have in mind based on the input feature data. In some embodiments, a set of candidate predictions with the least error or error metric based on the comparison with the label data will be considered as the intentions 304 for display to the user for selection.

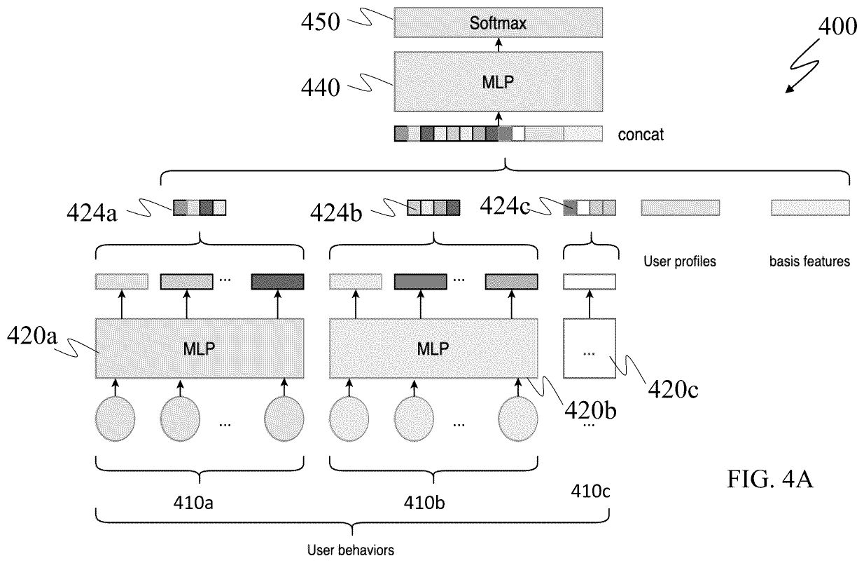

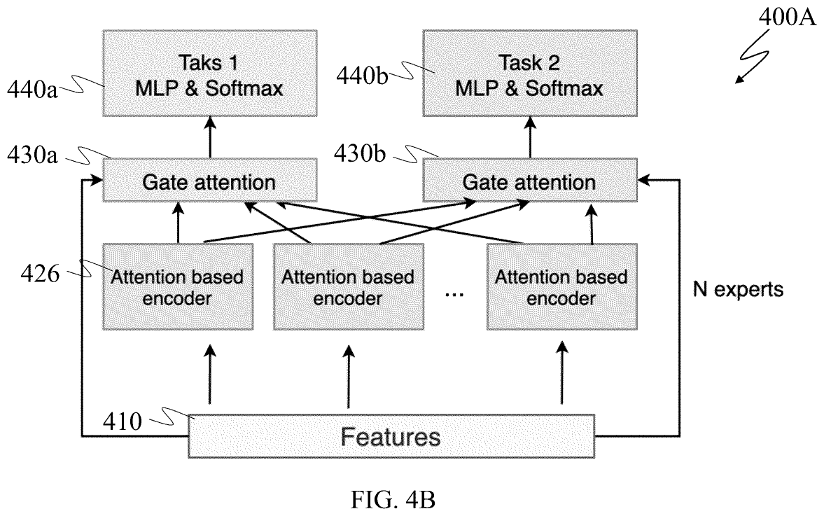

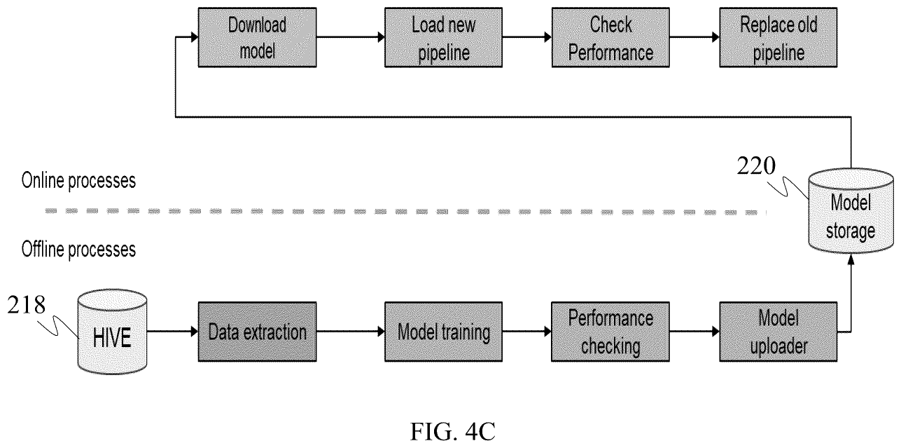

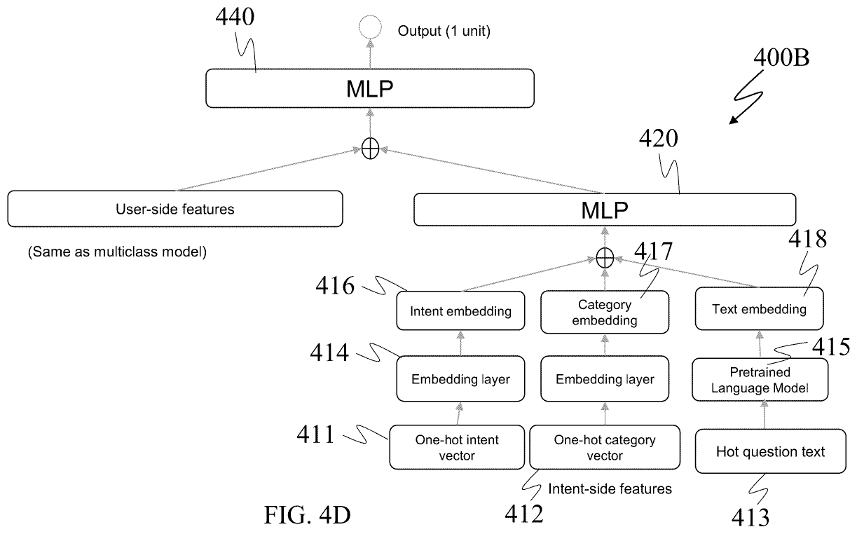

FIG. 4A is a particular embodiment 400 of the intention prediction service 206, comprising two machine learning layers 420, 440.

The first machine learning layer 420 may be a first multi-layer perception neural network (MLP), and the second machine learning layer 440 may be a second MLP 440.

The first machine learning layer 420 may comprise a plurality of MLP, referenced as 420a, 420b, 420c, etc. The MLP 420a may be configured to receive feature data 410 associated with various categories or classified feature data, such as feature data associated with orders category 410a, feature data associated with checkouts category 410b, and chatbot logs 410c, etc.

The feature data 410a, 410b, may be sequential data, based on the focus on one order or checkout. The MLP 420a, 420b may be used to extract the feature data from each group 410a, 410b, 410c. In some embodiments, for feature data relating to user profile and other basic features, an embedding layer may be used to extract the vectorized representation.

The extraction of feature data from each group 410a, 410b, 410c may be performed via corresponding attention pooling steps 430a, 430b, 430c. The extracted feature data may then be concatenated to form an input set into the second machine learning layer 440.

The second machine learning layer 440 may comprise one MLP 440 for modelling at least one relationship between one group of feature data and another group of feature data in the plurality of feature groups 440a, 440b, 440c.

The output of the second MLP 440 may be input to a softmax function module 450 to calculate the probability value to select the most probable set of intents.

FIG. 4B shows another embodiment of the intention prediction service 206, modelled as a multi-task model 400A. The multi-task model 400A may be referred to as a multi-gate mixture-of-experts model, and comprises feature data 410, first MLP in the form of attention gate encoders 426, and second MLP 440a, 440b, etc.

The attention-based encoders 426 are configured to extract feature representation, while the MLP 440a, 440b may be configured to model feature interaction to provide the final output. In some embodiments, each of the multiple feature encoders 426 may be regarded as an expert. In a system of N experts (N being an integer greater than 0), N experts may be configured to output N different feature representation. For different tasks, the gate attention 430 may be used to extract the representation from the different experts 426. If the tasks are highly correlated, then each gate attention 430 may be trained to use features from the each of the experts 426.

FIG. 4C shows an embodiment of an auto-training pipeline of the auto-training function of the intent prediction training module 219. The auto-training function may comprise an online process and an offline process. As shown in FIG. 4C, the offline process may commence with the obtaining of feature data from the logs database 218. The feature data is used for data extraction, model training, and performance checking, before being uploaded to the model storage 220. The model may then be downloaded by the intention prediction service 206, and loaded into its data pipeline, for replacement of the old (current) pipeline after performance checks have been conducted.

In some embodiments, the performance checks may include statistical measurements that may include accuracy indicators, such as root mean square (RMS) related measurements.

In some embodiments, where the intent prediction model is developed using non-limiting examples of such accuracy indicators include Python functions such as precision@k, recall@k, NDCG@k, etc.

FIG. 4D shows another embodiment of the prediction service 206, wherein the feature data may be grouped according to an intent feature data group, or a user specific feature data group.

The intent feature data group may comprise a hot question text data 413, a one-hot intent data 411, and a one-hot category data 412. Such data may be tagged according to whether the user 1000 has clicked on the same previously. In some embodiments, any predicted intent comprising label data may be pre-processed to remove any label data bias.

Each of the intent group data 411, 412, 413 may be further pre-processed before being input into the MLP 420. In the embodiment shown in FIG. 4D, the one-hot intent vector 411 and the one-hot category vector 412 may be embedded via an embedding layer 414 to form an intent embedding data 416 and a category embedding data 417. The hot question text data 413 may be input to a pretrained language model 415 to form a text embedding data 418. The three embedding data 416, 417, 418 may be combined as an input to the MLP 420.

Extracted feature data from the MLP 420 may be combined with the user-side features and input into the MLP 440.

It is appreciable that the training of the MLP 420, 440 may require a large amount of high-quality training data. In some embodiments, training data may be considerably reduced or streamlined based on feature data associated with click-through rate (CTR). In some embodiments, CTR can be used to gauge how well the predicted intents are performing. For example, if a particular intent is always selected by a substantial number of users of the chatbot system, the intent will have a relatively higher CTR, which will render the predicted intent more likely to be displayed as an intent on the GUI 300.

In some embodiments, the predicted intentions 304 may include a set of questions categorized based on an order, transaction, delivery, or other issues.

In some embodiments, the predicted intentions 304 may be further ranked for display (ranked intent list), wherein the higher ranked label data in the predicted intentions 304 may be displayed in a higher priority slot within the GUI 300. In some embodiments, the ranked intent list may further be ordered depending on a predefined strategy. In one such embodiment, a hot question may take precedence over a shortcut, followed by a category hot question slot.

In some embodiments, the intent prediction service 206 may be configured to receive the selected intent (label data) of the user. The selected intent may be used to update the database 218 for the training of the intent prediction training module 219.

In some embodiments, the intention predictions service 206 may be configured to receive any input from any user 1000, the input not selected from the list of label data. Such input may be in the form of a typed input into text box 306. The typed input may be used to update the database 218 for the training of the intent prediction training module 219.

In some embodiments, upon detection that a user 1000 is logged into the chatbot system using his/her login credentials, real time feature data may be retrieved from the feature service 215. Such real time feature data may include the latest order states and the account states associated with the user 1000. It is contemplated that the real time feature data of the present disclosure may comprise mainly of structured data.

In some embodiments, where a user 1000 made a plurality of transactions in the form of several orders at the same time, the user 1000 may be related to only one or a few of the orders. In such an operating example, the model 400A may be suitable. In particular, the attention mechanism of model 400A may be suitable for the multiple orders. For each order, data is extracted and mapped using an embedding layer and a vector is used to represent the order states. In the case of the several orders, there is a list of vectors, each vector representing one order. Attention pooling may then be utilized to select one or two or several most relevant order information.

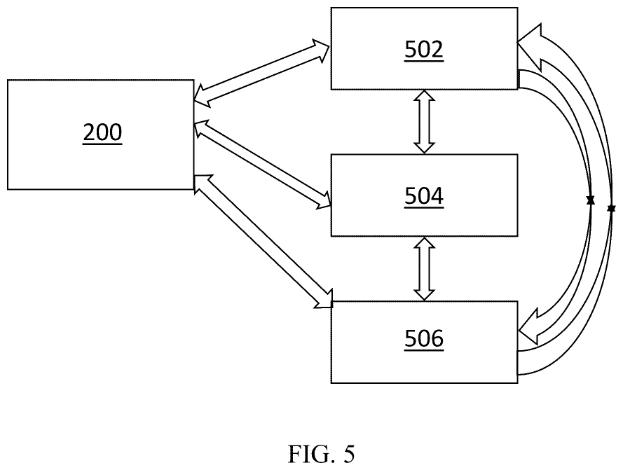

In some embodiments as shown in FIG. 5, the intent prediction system 200 may be configured in data communication with at least one of the following modules: a typing suggestion module 502, an intent recognition module 504, and a related article suggestion module 506. The intent prediction system 200 may be arranged in data communication directly to each of the modules 502, 504, 506, as shown, or may indirectly arranged in data communication via a remote network, such as a cloud service. Each of the typing suggestion module 502, the intent recognition module 504, and the related article suggestion module 506 may be configured to be data connected to one another.

The typing suggestion module 502 may be configured to detect an entry into the text box 306 and provide further suggestion(s) as the user 1000 enters or keys in his/her entry.

The intent recognition module 504 may be used to detect a selected intention of the user 1000 as he/she selects an intention output from the intent prediction system 200 or a keyed into the text box 306. The intent recognition module 504 is configured to generate a response based on the data entered into the text box 306.

The related article suggestion module 506 may be configured to display a list of further suggestions (e.g., related articles) related to the user entry into the text box 306. The list of further suggestions may be displayed to the user after one or more responses have been provided to the user by the chatbot. In some embodiments, the related article suggestion module 506 may be configured to detect and parse the response provided by the chatbot to the user. In some embodiments, the one or more responses may be a solution to resolve an issue the user faces. The related article suggestion module 506 may be configured to extract one or more keywords from the user entry into the text box 306 to provide further suggestions that the user may be interested in.

In some embodiments, the related article suggestion module 506 may include an offline or real-time database for mining or identifying the related article based on entered text from the user. In some embodiments, the related article suggestion module 506 may include a relevance model, the relevance model trained to produce a ranked output set according to the degree of relevance between the related article and the input data entered into the text box 306.

In some embodiments, the related article suggestion module 506 may include a reranking module. The reranking module may be configured to re-rank the ranked output set based on at least one user related feedback, such as whether the user subsequently considers any of the related article relevant and input the same. Any related article not subsequently selected by the user after a pre-determined number of displays for selection, or expressly indicated by the user to be not relevant, for example, via a feedback form, may be re-rank to a lower rank.

In some embodiments, the reranking module may be configured to obtain user behaviour data for the purpose of ranking/reranking. Such behaviour data may be based on the feature data relating to user profile as described.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

Aspects of the disclosed invention can include one or more of the following, including variations thereof:

Aspect 1. A method for predicting an intention of a user of a chatbot system, the method comprising steps for: receiving or obtaining feature data from a plurality of feature sources; classifying the feature data into a plurality of feature groups; extracting the feature data using a first machine learning layer; and modelling at least one relationship between one group of feature data and another group of feature data in the plurality of feature groups using a second machine learning layer.

Aspect 2. The method of Aspect 1, wherein the first machine learning layer comprises a first multi-layer perceptron neural network, and the second machine learning layer comprises a second multi-layer perception neural network.

Aspect 3. The method of any of Aspects 1 to 2, further comprising: calculating a probability of the intention based on the modelled at least one relationship.

Aspect 4. The method of Aspect 3, further comprising: displaying the intention, in the form of one or more suggestions to the user for selection as input to the chatbot system.

Aspect 5. The method of any of Aspects 1 to 4, further comprising: detecting whether the user has entered the chatbot system based on a pre-determined user login data.

Aspect 6. The method of Aspect 5, wherein in a positive determination that the user has entered the chatbot system, the method further comprises: obtaining feature data associated with the user based on the pre-determined user login data.

Aspect 7. The method of Aspect 6, wherein the feature data associated with the user includes an intent feature data group, and a user specific feature data group.

Aspect 8. The method of Aspect 7, wherein the user specific feature data includes past transaction data of the user, user profile data, credit status data of the user, or a combination thereof.

Aspect 9. The method of any of Aspects 7 to 8, wherein the intent feature data includes a question text data, a one-hot intent data, a one-hot category data, or a combination thereof.

Aspect 10. The method of any one of claim 1, wherein the feature data includes at least one of a real time feature and an offline feature.

Aspect 11. The method of any of Aspects 1 to 9, wherein the first machine learning layer is implemented as a multi-gate mixture-of-experts model.

Aspect 12. A system for predicting an intention of a user of a chatbot system, the system comprising at least one processor configured to: model at least one relationship between one group of feature data and another group of feature data in the feature groups using a machine learning layer; identify at least one intention of the user based on the at least one relationship between one group of feature data and another group of feature data in the feature groups; and display, in a graphical user interface, the at least one intention in the form of one or more suggestions to the user for selection as input to the chatbot system.

Aspect 13. The system of Aspect 12, wherein the machine learning layer comprises a multi-layer perception neural network.

Aspect 14. The system of any of Aspects 12 to 13, wherein the processor is configured to: detect whether the user has entered the chatbot system based on a pre-determined user login data.

Aspect 15. The system of Aspect 14, wherein in a positive determination that the user has entered the chatbot system, the processor is configured to obtain feature data associated with the user based on the pre-determined user login data.

Aspect 16. The system of Aspect 15, wherein the feature data associated with the user includes an intent feature data group, and a user specific feature data group.

Aspect 17. The system of Aspect 16, wherein the user specific feature data includes past transaction data of the user, user profile data, credit status data of the user, or a combination thereof.

Aspect 18. The system of any of Aspects 16 to 17, wherein the intent feature data includes a question text data, a one-hot intent data, a one-hot category data, or a combination thereof.

Aspect 19. A computer program element comprising program instructions, which, when executed by one or more processors, cause the one or more processors to perform the method of any one of claims 1 to Aspect 11.

Aspect 20. A computer-readable medium comprising program instructions, which, when executed by one or more processors, cause the one or more processors to perform operations for: receiving or obtaining feature data from a plurality of feature sources; classifying the feature data into a plurality of feature groups; extracting the feature data using a first machine learning layer; and modelling at least one relationship between one group of feature data and another group of feature data in the plurality of feature groups using a second machine learning layer.

Aspect 21. A user interaction system comprising: a chatbot system, configured to detect a user entering the chatbot system and provide the intention in the form of one or more suggestions to the user; a typing suggestion module, the typing suggestion module configured to detect a selected suggestion and provide further suggestion(s) as the user enters or keys in the selected suggestion; an intent recognition module, the intent recognition module configured to detect the selected suggestion of the user, the intent recognition module further configured to generate a response based on the selected suggestion; and a related article suggestion module, the related article suggestion module configured to display a list of related articles, the list of related articles related to the selected suggestion and the response.

Aspect 22. The system of Aspect 21, wherein the related article suggestion module comprises a relevance model, the relevance model trained to produce a ranked output set according to a degree of relevance between the list of related articles and the selected suggestion or the response.

Aspect 23. The system of Aspect 22, wherein the related article suggestion module includes a reranking module, the reranking module configured to re-rank the ranked output set based on at least one user feedback.

Aspect 24. The system of Aspect 23, wherein the at least one user feedback comprises a positive or negative determination that the user subsequently selects any one of the related article from the ranked output set.

Aspect 25. The system of any of Aspects 23 to 24, wherein the reranking module may be configured to obtain user behavior data for the reranking.

1. A method for predicting an intention of a user of a chatbot system, the method comprising steps for:
receiving or obtaining feature data from a plurality of feature sources;
classifying the feature data into a plurality of feature groups;
extracting the feature data using a first machine learning layer; and
modelling at least one relationship between one group of feature data and another group of feature data in the plurality of feature groups using a second machine learning layer.

2. The method of claim 1, wherein the first machine learning layer comprises a first multi-layer perceptron neural network, and the second machine learning layer comprises a second multi-layer perception neural network.

3. The method of claim 1, further comprising:
calculating a probability of the intention based on the modelled at least one relationship.

4. The method of claim 3, further comprising:
displaying the intention, in the form of one or more suggestions to the user for selection as input to the chatbot system.

5. The method of claim 1, further comprising:
detecting whether the user has entered the chatbot system based on a pre-determined user login data.

6. The method of claim 5, wherein in a positive determination that the user has entered the chatbot system, the method further comprises:
obtaining feature data associated with the user based on the pre-determined user login data.

7. The method of claim 6, wherein the feature data associated with the user includes an intent feature data group, and a user specific feature data group.

8. The method of claim 7, wherein the user specific feature data includes past transaction data of the user, user profile data, credit status data of the user, or a combination thereof.

9. The method of claim 7, wherein the intent feature data includes a question text data, a one-hot intent data, a one-hot category data, or a combination thereof.

10. The method of any one of claim 1, wherein the feature data includes at least one of a real time feature and an offline feature.

11. The method of claim 1, wherein the first machine learning layer is implemented as a multi-gate mixture-of-experts model.

12. A system for predicting an intention of a user of a chatbot system, the system comprising at least one processor configured to:
model at least one relationship between one group of feature data and another group of feature data in the feature groups using a machine learning layer;
identify at least one intention of the user based on the at least one relationship between one group of feature data and another group of feature data in the feature groups; and
display, in a graphical user interface, the at least one intention in the form of one or more suggestions to the user for selection as input to the chatbot system.

13. The system of claim 12, wherein the machine learning layer comprises a multi-layer perception neural network.

14. The system of claim 12, wherein the processor is configured to:
detect whether the user has entered the chatbot system based on a pre-determined user login data.

15. The system of claim 14, wherein in a positive determination that the user has entered the chatbot system, the processor is configured to obtain feature data associated with the user based on the pre-determined user login data.

16. The system of claim 15, wherein the feature data associated with the user includes an intent feature data group, and a user specific feature data group.

17. The system of claim 16, wherein the user specific feature data includes past transaction data of the user, user profile data, credit status data of the user, or a combination thereof.

18. The system of claim 16, wherein the intent feature data includes a question text data, a one-hot intent data, a one-hot category data, or a combination thereof.

19. A computer program element comprising program instructions, which, when executed by one or more processors, cause the one or more processors to perform the method of any one of claims 1 to 11.

20. A computer-readable medium comprising program instructions, which, when executed by one or more processors, cause the one or more processors to perform operations for:
receiving or obtaining feature data from a plurality of feature sources;
classifying the feature data into a plurality of feature groups;
extracting the feature data using a first machine learning layer; and
modelling at least one relationship between one group of feature data and another group of feature data in the plurality of feature groups using a second machine learning layer.
